(19) United States
(12) Patent Application Publication
(10) Pub. No.: US 2024/0293882 A1
(43) Pub. Date: Sep. 5, 2024

(54) Method for Repairing Damaged Bolt

(71) Applicant: Team Industrial Services, Inc., Sugar Land, TX (US)

(72) Inventor: Brady BAIRD, Sugarland, TX (US)

(21) Appl. No.: 18/018,223

(22) PCT Filed: Aug. 3, 2021
(86) PCT No.: PCT/US2021/044358

§ 371 Date: Jan. 26, 2023

Related U.S. Application Data
(60) Provisional application No. 63/060,263, filed on Aug. 3, 2020.

(51) Int. Cl. B23G 9/00

(52) U.S. Cl. CPC B23G 9/009

(57) ABSTRACT

A method for repairing a damaged bolt located on a baseplate in a bolted joint, the damaged bolt having a nut threaded thereon, and the damaged bolt having a deformed portion and a residual portion, wherein the residual portion is at least partially within the nut, the method comprising: removing the deformed portion of the bolt; removing the nut from the residual portion of the bolt; inspecting the residual portion of the bolt; installing a coupling over the residual portion of the bolt; installing an anchor bolt into the coupling; installing a bolt stool over the coupling, the anchor bolt, and the residual portion of the bolt; installing a securing nut onto the anchor bolt to secure the bolt stool in place; and tensioning the anchor bolt with a tensioner to a predetermined tension.

### PRIOR RELATED APPLICATIONS

This application claims priority to U.S. Ser. No. 63/060,263, filed Aug. 3, 2020, which is incorporated by reference in its entirety for all purposes.

### FIELD OF INVENTION

In general, this invention relates to method and device for repairing damaged industrial bolts, such as anchor bolts used in wind towers, and more particularly to a method and device for repairing damaged industrial bolts without the need to replace the damaged bolts.

### BACKGROUND OF INVENTION

Unfortunately, catastrophes have happened due to poor bolted joint integrity management causing millions of dollars in damage and preventable fatalities. Despite the high risk, most major companies stilt operate without a comprehensive and current set of policies, processes and procedures in place related to bolted joints.

A survey of 99 plants indicated that bolted joints are the 3rd worst area of performance in general and the worst area at the corporate level. The industry focuses heavily on welded joints and inspection while in comparisons practically ignores the bolted flange joint despite the fact the bolted flange joint is holding back the same pressure and process as the welded joint.

What is needed, therefore, is an improved method of inspection and repair of bolts used in bolted joints.

### SUMMARY

This summary is provided to introduce a selection of concepts that are further described below in the detailed description. However, many modifications are possible without materially departing from the teachings of this disclosure.

Accordingly, such modifications are intended to be included within the scope of this disclosure as defined in the claims. This summary is not intended to identify key or essential features of the claimed subject matter, nor is it intended to be used as an aid in limited the scope of the claimed subject matter.

An embodiment of the present disclosure provides a method for repairing a damaged bolt in a bolted flange joint, the damaged bolt having a nut threaded thereon and the damaged bolt having a deformed portion that may or may not extend beyond the nut and a residual portion within the nut, the method comprising: removing the deformed portion of the bolt; removing the nut from the residual portion of the bolt; inspecting the residual portion of the bolt; installing a coupling over the residual portion of the bolt; installing an anchor bolt into the coupling; installing a bolt stool over the coupling, anchor bolt, and residual portion of the bolt; installing a securing nut onto the anchor bolt to secure the bolt stool in place; and tensioning the anchor bolt.

Optionally, before removing the nut from the residual portion of the bolt, a finite element analysis may be performed to assess the torque limit to be applied for removing the nut. This ensures no structural damage to the bolt due to the nut removal.

The bolt stool used herein comprises a housing with an inner space, a top surface, and a hole on the top surface that connects to the inner space. The inner space is sized to fit over the coupling while allowing the extended portion of the anchor bolt to extend through the hole.

### BRIEF DESCRIPTION OF THE FIGURES

Certain embodiments of the disclosure will hereafter be described with reference to the accompanying drawings, wherein like reference numerals denote like elements. It is emphasized that, in accordance with standard practice in the industry, various features are not drawn to scale. In fact, the dimensions of various features may be arbitrarily increased or reduced for clarity of discussion. It should be understood, however, that the accompanying figures illustrate the various implementations described herein and are not meant to limit the scope of various technologies described herein, and:

FIG. 1 shows a bolted flange joint having three damaged anchor bolts.

FIG. 2 illustrates removing deformed portion of the damaged bolt.

FIG. 3 illustrates removing the nut from the residual bolt.

FIG. 4 illustrates installation of an all-thread-bar coupling.

FIG. 5 illustrates installation of an anchor bolt into the all-thread-bar coupling.

FIG. 6 illustrates installation of a bolt stool.

FIG. 7A-B illustrates a perspective and cutaway view of installation of a hex nut onto the anchor bolt.

FIG. 8 illustrates tensioning the anchor bolt.

FIG. 9A-B shows a perspective and cutaway view of a complete installation.

FIG. 10. Elastic-plastic constitutive models used for the plastic collapse and local failure analyses.

FIG. 11. Elastic-perfectly plastic constitutive models used for the limit load analysis.

FIG. 12. Contours (psi) of a) von Mises stress, b) shear stress, and c) axial stress considering a coefficient of friction of 0.5.

### DETAILED DESCRIPTION

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements.

In general, the present disclosure relates to bolted flange joints, and more particularly to inspection and repair of damaged bolts. To illustrate the methodology of the present disclosure, inspecting and repairing industrial anchor bolts, such as those used in wind towers will be described.

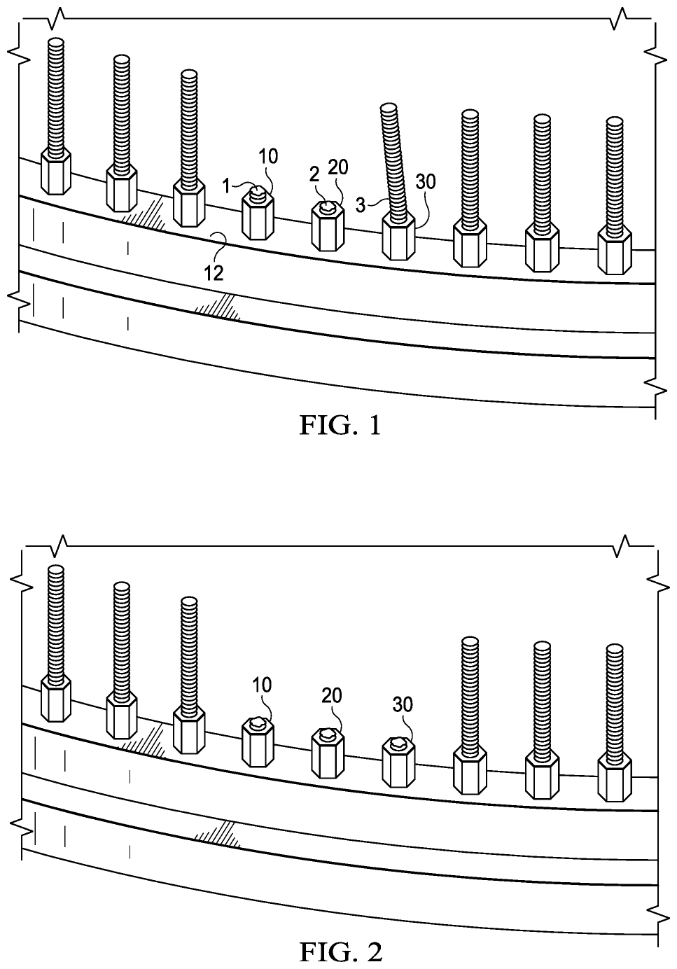

FIG. 1 shows a bolted joint having a plurality of bolts bolted on a base plate 12. As shown in FIG. 1, two bolts or studs sheared off (indicated by numerals 1 and 2 in FIG. I) and one bolt bent (indicated by numeral 3). For all three damaged bolts, the nuts (10, 20, 30) remain intact. This is common for bolted joint where corrosion, rust, external forces that cause deformation to the bolts. The deformation may occur at the portion not covered by the nuts, or may occur at the portion covered by the nuts. As discussed further below, the disclosed method is applicable to either situations.

FIG. 2 illustrates initial preparation work for any bent, deformed, or otherwise damaged bolts or studs. Specifically, it is necessary to remove any bent or otherwise deformed bolts (bolt 3 in FIG. 1) by cutting the damaged anchor bolts down to the nut 30. Alternatively, the damaged anchor bolts can be machined down.

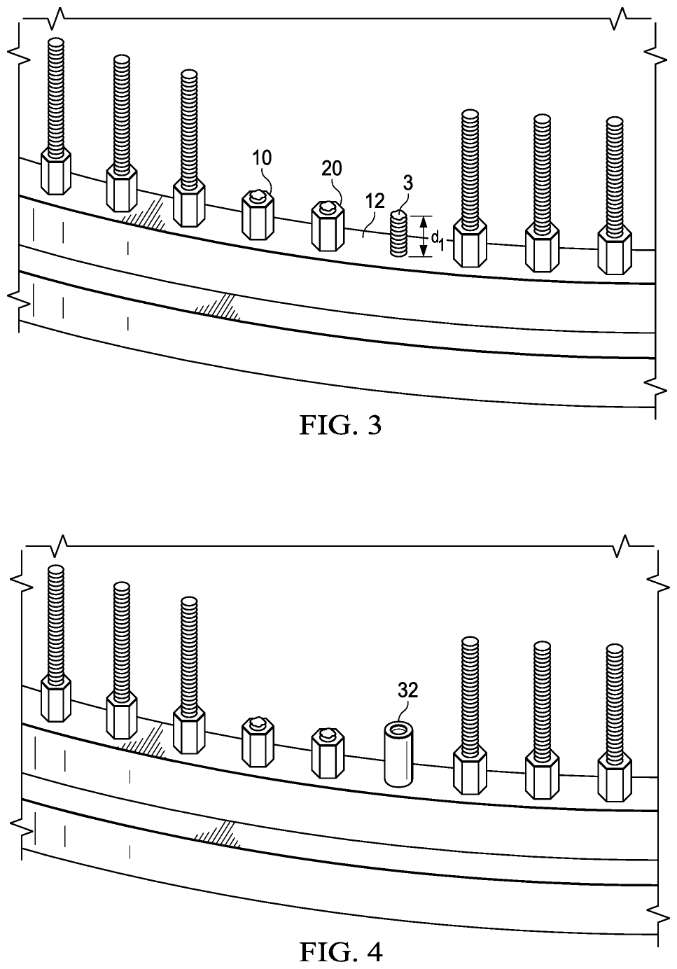

FIG. 3 illustrates the first step in the single stud replacement method of the present disclosure. This method ensures that reduced anchor bolt loads remain minimal by working on one anchor bolt at a time. As shown in FIG. 3, the nut 30 has been removed from the residual bolt 3. However, the removal of the nut should be performed with caution, as excess torque may damage the bolt due to deformation or rust. In one embodiment, an additional step of analyzing the torque limit for removing the nuts is performed so as to prevent any damage caused by excess torque. In one embodiment, a finite element analysis (FEA) may be performed to determine the torsional stress limit of the damaged bolts and demonstrate the integrity of the bottom flange. For example, for a bolts and nuts made of ASTM A722 Gr.150 material, having yield strength of 120 ksi and tensile strength of 150 ksi, a maximum torque limit of 4,200 lb-ft is determined to be safely applied to remove the nut before risk of ductile failure of the bolt, assuming a load factor of 1.35 and a coefficient of friction between the nut and washer of 0.5. Different sizes and materials of bolts and nuts would require different analysis in order to maintain proper structural integrity of the bolts and nuts.

The residual bolt can be measured and the bearing surfaces can be inspected. Additionally, the remaining anchor bolt can be inspected for corrosion, threads, and deformation. The residual length d1 should be sufficient to thread the coupling (discussed below with regard to FIG. 4) on to the minimum required thread engagement for the coupling. In one embodiment, the residual length is approximately half of the length of the coupling. If the residual length is insufficient, an option would be to machine down the baseplate 12 around the residual bolt 3 to reveal additional length of the bolt 3. If the residual length is still not long enough, an alternative option would be to remove the bolt 3 altogether and replace it with another bolt. However, this option would require substantial time and effort, especially in the wind turbine industry, to complete.

After ensuring that the length of residual bolt 3 is adequate, an all-thread-bar coupling 32 is installed over the residual bolt 3 as shown in FIG. 4.

The coupling 32 is threaded to entirely cover the residual bolt 3 and contact the baseplate 12 in order to provide necessary mechanical strength. Therefore, the coupling will meet required ASTM specifications and rated to correct ultimate strength. Specifically, the coupling will meet or exceed 100% of the all-thread bar's published ultimate strength and meet ACI 318 Section 25.5.7.1 for mechanical rebar connections.

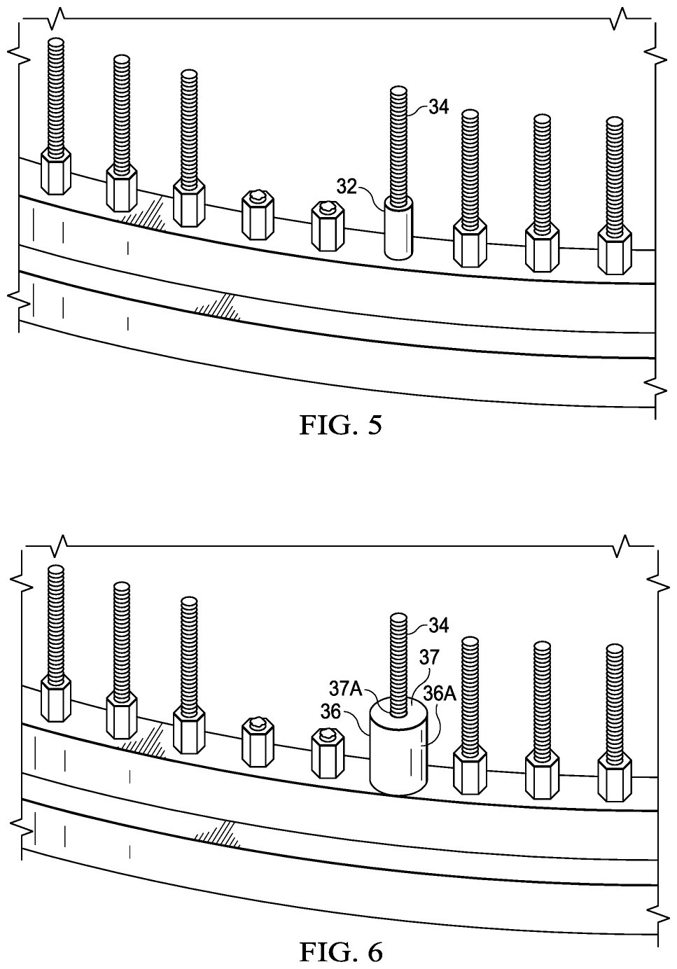

FIG. 5 shows installation of an anchor bolt 34 into the all-thread-bar coupling 32. The anchor bolt 34 should be of sufficient strength and length to properly tension the anchor bolt. Additionally, the length of the anchor bolt 34 inside the coupling 32 should also be sufficient to provide necessary structural strength as discussed above. If the residual length d1 of the residual bolt 3 exceeds more than half of the coupling 32, an additional step of reducing the residual length.

A bolt stool 36 is then installed over the coupling 32, the anchor bolt 34 and the residual bolt 30, as shown in FIG. 6. The bolt stool 36 is designed to support the bolt loads, acts as a top hat to sit tension on, and is sized to fit on the baseplate as allowable. The bolt stool 36, in some embodiments, can be sealed to prevent corrosion with flowable material post tension. The bolt stool 36 has a housing 36A that comprises a top surface 37. On the top surface 37 there is provided a hole 37A through which the anchor bolt 34 extends.

The material and design of the bolt stool must be able to withstand the applied stresses for its intended application as well as the specified tensioning. The material and structural design of the bolt stool 36 must meet or exceed 100% of the all-thread bar's published ultimate strength and meet ACI 318 Section 25.5.7.1 for mechanical rebar connections. Additionally, the bolt stool 36 has been tested for finite element analysis (FEA) to ensure that its structural integrity can withstand the applied stress.

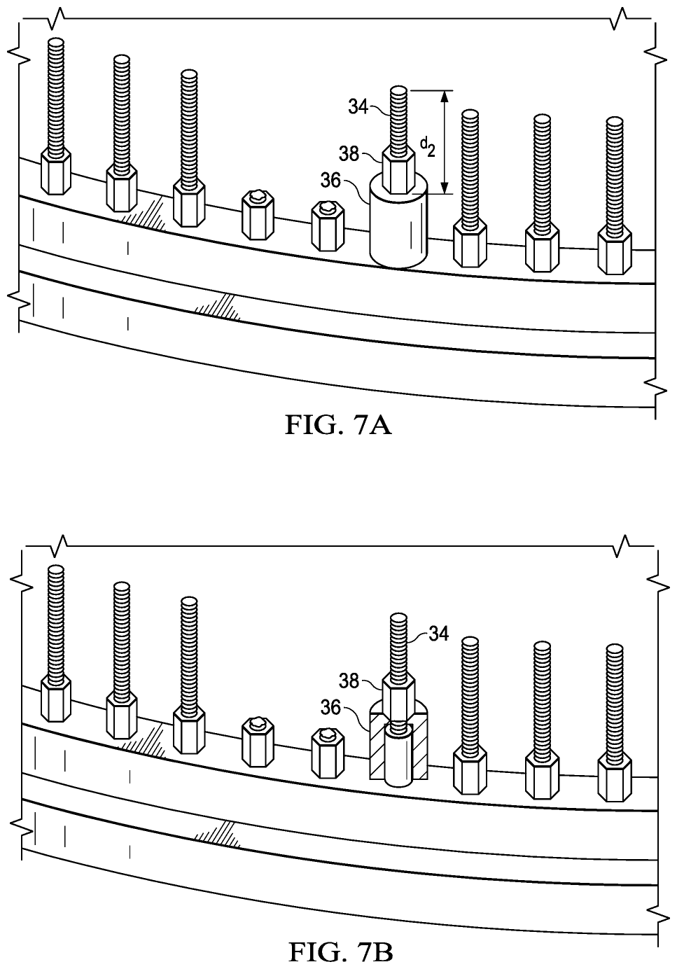

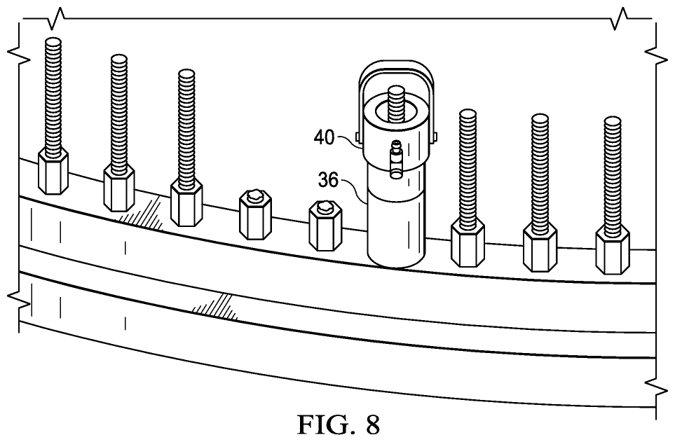

As shown in FIGS. 7A (perspective) and 7B (cutaway view), a heavy hex nut 38 with a hardened washer is threaded onto the anchor bolt 34 to secure the bolt stool 36 in place. It is noted that the anchor bolt 34 extends beyond the top surface 37 of the bolt stool 36 by at least a length d2. The length d2 should be longer than the minimum length necessary for a tensioner (shown in FIG. 8) to apply the tension as required by corresponding specification. In one example, the tension applied is at least 80,000 lb-ft.

Finally, as shown in FIG. 8, a tensioner 40 is used to tension the anchor bolt 34 to specification. The tensioner 40 sits on top the bolt stool 36 and applies an axial tension to the anchor bolt 34 such that the base plate

To ensure proper tensioning, the anchor bolt 34 should have sufficient length (stud protrusion, measured from the top surface of the bolt stool to the tip of the anchor bolt 34) as required by the tensioner 40. In one embodiment, the tensioner 40 requires at least 9.1 inches of stud protrusion.

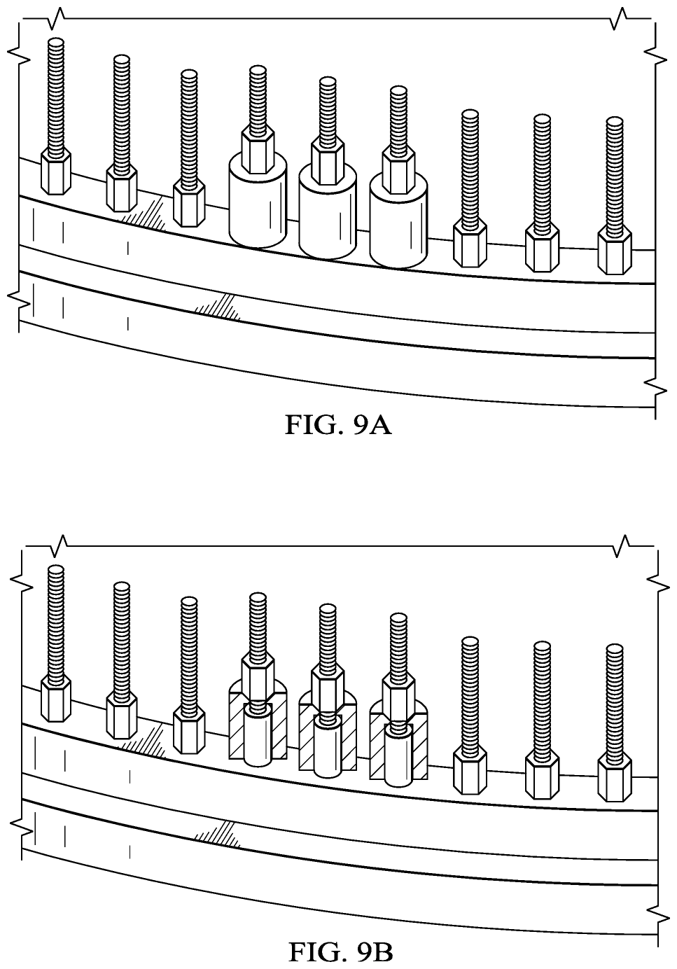

The process is then repeated for the remaining two anchor bolts (1, 2). The complete repaired installation is shown in FIG. 9 (perspective and cutaway views).

Embodiments of the present disclosure provide the benefits such as, but not limited to, the following: (a) engineering assessment of the repair such as bolt loads and stresses, materials, bolt stool design, and bottom flange stresses; (b) Finite Element Analysis (FEA) performed on the bolt stool and areas within the stress zone; and (c) life cycle analysis to ensure the life of the bolts is known and planned for.

### FINITE ELEMENT ANALYSIS

FEA is the simulation of a given physical phenomenon or object using the numerical technique called finite element method (FEM). To make simulations, a mesh, consisting of up to millions of small elements that together form the shape of the structure, need to be created. Calculations are made for every single element, and the combination of each individual results lead to the final result of the structure. For example, the Level 3 fitness-for-service (FFS) stress analysis procedures outlined in API 579-1/ASME FFS-1 (published by the American Petroleum Institute (API) and the American Society for Mechanical Engineers (ASME)) Annex 2D can be used. An FFS assessment is a multi-disciplinary approach to determine if a given structure is fit for continued service. The outcome of an FFS assessment is a decision to operate as is, repair, retire, or re-rate.

API 579-1/ASME FFS-1 standard comprises three levels of assessment for each damage mechanism:
1. Level 1 is a simplified and conservative analysis that is used for initial screening purposes.
2. Level 2 is an engineering analysis that uses standard formulae to perform the FFS assessment. Typical Level 2 FFS calculations can be performed with more complex spreadsheets or custom software.
3. Level 3 is an advanced assessment that may include computational fluid dynamics and finite element simulation to obtain a detailed response from a structure or a system of structures composed of complex geometries and subjected to complex applied loads. These analyses may involve two-dimensional (2D) or three-dimensional (3D) modeling to accurately determine the stresses. These stresses can then be evaluated to determine the suitability of the component for continued service.

### Finite Element Mesh

FEA were performed using the Abaqus/Standard finite element solver. The primary mesh consisted of linear and quadratic hexahedral elements (C3D8R and C3D20R respectively). For load cases considering wind, linear pipe elements (PIPE31) were used to transfer the wind overturning moment to the model.

### Material Properties and Models

Elastic-plastic and elastic-perfectly plastic material models were considered. Specified minimum material properties were sourced from the appropriate standards and are summarized in Table 1.

TABLE 1
Specified Minimum Material Properties

| Property | Value | | | |
|---|---|---|---|---|
| Material | 5355 NL | ASTM A722 | DIN/EN | Non-shrink |
| | EN 10025-3 | Gr. 150 | 1.0511 | Grout |
| Component | Tower Shell | Bolts and | Bolt Stools | Bottom |
| | and Bottom | Nuts | | Flange |
| | Flange | | | Grout |
| Yield | 46.0 ksi | 120.0 ksi | 40.6 ksi | N/A |
| Strength | | | | |
| Tensile | 65.0 ksi | 150.0 ksi | 79.7 ksi | N/A |
| Strength | | | | |
| Modulus of | 29,400 ksi | | | 4,351 ksi |
| Elasticity | | | | |

| Density | 0.28 lb in³ | |
|---|---|---|
| Poisson's | 0.3 | 0.15 |
| Ratio | | |

### Loads, Boundary Conditions, and Constraints

For the torsional limit analysis, in addition to the dead loads, a ramped torque was applied to the outer surface of the nut using a kinematic coupling constraint and control point. For load cases that consider wind loading, the wind overturning moment was applied as an equivalent point load to the top of a beam model representing an approximation of the whole tower shell and the base shear was applied as an equivalent surface traction to the bottom surface of the bottom flange. The application of the loads in Table 2.

TABLE 2
Loading Summary

| | AMSE | | | Abnormal | |
|---|---|---|---|---|---|
| Load | Designation | Extreme Wind | | Extreme Wind | |
| Gravity (Self Weight) | Dead Load | 32.2 ft/s² | | | |
| | (D) | | | | |
| Vertical Tower Load | Dead Load | 856 kip | | | |
| | (D) | | | | |
| Bolt Pre-Tension | N/A | 82.0 KIP | | | |
| Overturning Moment | Wind Load | 47,933 | kip-ft | 66,764 | kip-ft |
| | (W) | | | | |
| Base Shear | Wind Load | 167 | kip | 225 | kip |
| | (W) | | | | |

Additional boundary conditions and constraints include:
Symmetry enforced with a constraint in the normal direction along the circumferential symmetry planes,
Constraints in all directions on the bottom of the bottom flange grout,
Constraints in all directions on the bottom of the bolts,
Full constraint of the bottom point of the beam model of the tower,
Tied contact interaction (no relative motion) between the bolts, bottom flange, and grout, and
Contact interaction with tangential friction between the nut and washer in the torsional limit analysis.

### Fitness-for-Service Assessment

Elastoplastic stress analyses were performed to determine if the components are protected against plastic collapse and local failure using guidance provided in API 579-1/ASME FFS-1 Annex 2D. These failure mechanisms are summarized hereinafter.

a. Torsional Limit Analysis

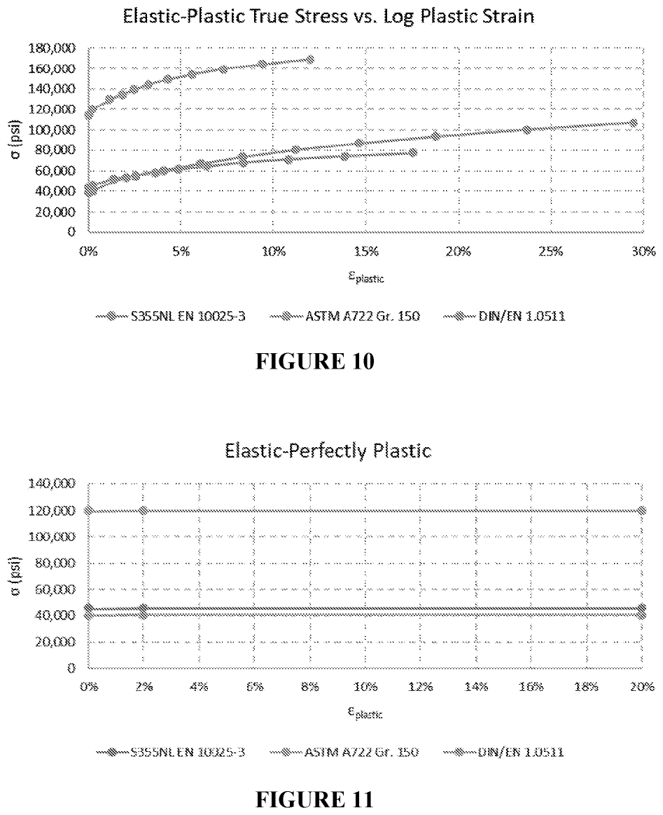

An elastic-plastic analysis was performed to determine at what applied torque gross plastic deformation (plastic collapse) of the bolt occurs. The full material stress-strain curve including hardening behavior (FIG. 10) was calculated using equations outlined in ASCE BPVC VIII Div. 2 Annex 3D. Plastic collapse occurs when the assessment can no longer converge on a nonlinear numerical solution (FEA) for the applicable load combinations found in Table 2D.3 of the FFS standard (Appendix A). Other known loads, such as wind, are not expected to influence the maximum torque that the bolt can withstand before ductile failure, only one of the five load cases were considered (Case 1: Primary Loads).

b. Bolt Repair Assembly Analysis

A limit load analysis (plastic collapse) and local failure analysis was performed to assess the bolt stool and bottom flange.

The limit load criterion uses an elastic-perfectly plastic material model (FIG. 11). Similar to the elastic-plastic plastic collapse criteria, protection against gross plastic deformation is defined by the convergence of the numerical solution (FEA). In this case, two applicable factored load combinations found in Table 2D.4 of the FFS standard (Appendix A) were assessed to include wind loading.

Local failure was assessed via an elastic-plastic stress analysis using the full material true stress-strain curve (FIG. 10) calculated using equations outlined in ASCE BPVC VIII Div. 2 Annex 3D. Loads were applied per Table 2D.4 in the FFS standard. Protection against local failure is demonstrated by satisfying the limiting strain criteria, which is determined by computing a strain limit damage ratio (SLDR) for the portions of the numerical model in question (Appendix A). The criterion is satisfied if the SLDR is less than 1.0.

### Results

a. Torsional Limit Analysis

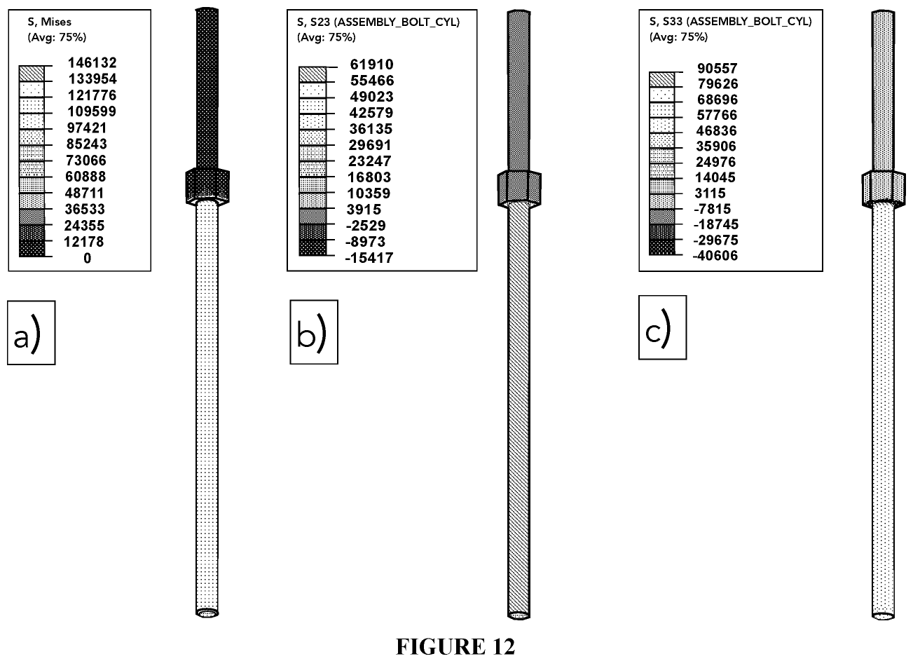

Applied torques up to 16,700 lb-ft and coefficients of friction ranging from 0.1 to 0.7 in increments of 0.2 were considered. As the design code of the anchor bolts is not defined in Table 2D.5 of API 579-1/ASME FFS-1, a load factor of 1.35 is recommended as this is the factor defined for extreme wind conditions. A coefficient of friction of 0.5 is recommended as this is a typical assumption for dry steel to steel material combinations in a sliding condition. FIG. 12 shows stress contours of the bolt using a coefficient of friction of 0.5. Table 3 shows a summary of load factor and coefficient of friction combinations. The highlighted value in Table 3 represents the maximum allowable torque that can be applied to the nut during removal before there is a heightened risk of the ductile failure of the bolt given the previously stated assumptions.

TABLE 3
Summary of the torsional limit analysis results

| Coefficient of | Load Factor/Maximum Allowable Torque (lb-ft) | | | | | | |
|---|---|---|---|---|---|---|---|
| Friction | 1.00 | 1.10 | 1.35 | 1.50 | 1.75 | 2.00 | 2.5 |
| 0.1 | 3,300 | 3,00 | 2,400 | 2,200 | 1,900 | 1,600 | 1,300 |
| 0.3 | 4,300 | 3,900 | 3,200 | 2,900 | 2,500 | 2,200 | 1,700 |
| 0.5 | 5,600 | 5,100 | 4,200 | 3,800 | 3,200 | 2,800 | 2,300 |
| 0.7 | 7,000 | 6,400 | 5,200 | 4,700 | 4,000 | 3,500 | 2,800 |

b. Bolt Repair Assembly Analysis

Both the bolt stool and bottom flange satisfied the limit load and local failure criteria. Convergence was achieved for all the plastic collapse load cases and all regions of the assessed components satisfied the local failure criteria with SLDR values less than 1.0.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims. The scope of the invention should be determined only by the language of the claims that follow. The term “comprising” within the claims is intended to mean “including at least” such that the recited listing of elements in a claim are an open group. The terms “a,” “an” and other singular terms are intended to include the plural forms thereof unless specifically excluded. In the claims, means-plus-function clauses are intended to cover the structures described herein as performing the recited function and not only structural equivalents, but also equivalent structures. It is the express intention of the applicant not to invoke 35 U.S.C. § 112, paragraph 6 for any limitations of any of the claims herein, except for those in which the claim expressly uses the words “means for” together with an associated function.

1. A method for repairing a damaged bolt located on a baseplate in a bolted joint, the damaged bolt having a nut threaded thereon, and the damaged bolt having a deformed portion and a residual portion, wherein the residual portion is at least partially within the nut, the method comprising:
a) removing the deformed portion of the damaged bolt;
b) removing the nut from the residual portion of the damaged bolt;
c) inspecting the residual portion of the damaged bolt;
d) installing a coupling over the residual portion of the damaged bolt;
e) installing an anchor bolt into the coupling;
f) installing a bolt stool over the coupling, the anchor bolt, and the residual portion of the damaged bolt;
g) installing a securing nut onto the anchor bolt to secure the bolt stool in place; and
h) tensioning the anchor bolt with a tensioner to a predetermined tension.

2. The method of claim 1, wherein the bolted joint is a bolted flange joint.

3. The method of claim 1, wherein the deformed portion extends beyond the nut.

4. The method of claim 1, wherein in step b) the nut is removed without causing structural damage to the residual portion of the bolt.

5. The method of claim 4, wherein an optional step b-1) is performed prior to the step b), comprising:
b-1) performing a finite element analysis (FEA) to determine a torsional stress limit of the damaged bolt.

6. The method of claim 1, wherein in step c) if the residual portion of the damaged bolt is shorter than a predetermined length, further comprising a step c-1): reducing the thickness of the baseplate at the damaged bolt to reveal additional residual portion of the damaged bolt.

7. The method of claim 6, wherein in step c) the predetermined length is at least half of the length of the coupling.

8. The method of claim 6, wherein in step c) if the residual portion of the damaged bolt is shorter than a predetermined length, further comprising a step c-2): reducing the length of the residual portion of the damaged bolt to the predetermined length.

9. The method of claim 1, wherein in step f) the bolt stool comprises a housing having a top surface, and a bottom opening into an inner space within the housing, wherein a hole is located on the top surface, and wherein the bottom opening and the inner space is sized to encompass the coupling and allowing the anchor bolt to extend through the hole.

10. The method of claim 9, wherein in step f) the anchor bolt has a first length extending beyond the top surface of the bolt stool, wherein the first length is at least the length required for the tensioner in step h).

11. The method of claim 1, wherein the bolted joint is used in a foundation of a wind turbine.

12. A bolt stool for repairing a damaged bolt located on a baseplate in a bolted joint, the damaged bolt having a coupling threaded thereon and an anchor bolt threaded on to the coupling, the bolt stool comprising:
a) a housing, wherein the housing having a top surface, a bottom opening, and an inner space; and
b) a hole located on the top surface;
wherein the bottom opening and the inner space are sized to encompass the coupling; and
wherein the hole is sized to allow the anchor bolt extending therethrough.
